(19) United States
(12) Patent Application Publication
(10) Pub. No.: US 2012/0124991 A1
(43) Pub. Date: May 24, 2012

(54) METHOD AND APPARATUS FOR LEVER STROKE ADJUSTMENT

(75) Inventor: John Larry Thomas, Cedarburg, WI (US)

(73) Assignee: HB PERFORMANCE SYSTEMS, INC., Mequon, WI (US)

(21) Appl. No.: 12/954,301

(22) Filed: Nov. 24, 2010

(51) Int. Cl. B60T 13/00; F16D 31/00

(52) U.S. Cl. 60/547.1; 60/327

(57) ABSTRACT

Disclosed herein is an apparatus for lever stroke adjustment that includes, a master cylinder body having a master cylinder body wall at least partially bounding an inside of the master cylinder body, a piston bore situated substantially inside the master cylinder body, a rotatable cam assembly extending through the master cylinder body wall and into the piston bore, the cam assembly having a cam shaft with a lobe portion positioned in the piston bore and a cam lever positioned outside of the master cylinder body. The apparatus further including, a piston having a compression passage that includes a first sealing surface and a poppet valve having a first poppet end with a poppet actuating surface and a second poppet end with a second sealing surface, wherein rotation of the cam assembly varies the distance between the first sealing surface and the second sealing surface.

### CROSS-REFERENCE TO RELATED APPLICATION

This application hereby incorporates herein by reference U.S. application Ser. No. ______ entitled “System And Method For An Adjustable Lever Assembly,” filed Nov. 24, 2010.

### FIELD OF THE INVENTION

The method and apparatus for lever stroke adjustment relates to lever actuated master cylinder assemblies.

### BACKGROUND OF THE INVENTION

Numerous types of vehicles, such as bicycles, All-Terrain Vehicles (ATV) and motorcycles, utilize a lever actuated master cylinder assembly to actuate a braking and/or clutch system. Such lever actuated master cylinder assemblies are positioned on a vehicle handlebar so as to allow a user to reach forward from the handlebar with their fingers and grasp an actuating lever. Pulling the lever toward the handlebar with their fingers (i.e., stroking the lever) actuates a braking or clutch system in communication with the lever actuated master cylinder assembly.

With many such systems, various lever adjustments can be performed to modify how and when the system reacts to the actuation of the lever. More particularly, some bicycle braking systems provide, for example, a lever dead-stroke (i.e., lever dead-band) adjustment to modify the point in the lever stroke where a piston in the lever actuated master cylinder assembly begins to build pressure to charge the braking system for braking the vehicle. In practice, some bicycle riders prefer a minimal lever dead-band that provides instant stopping power, while other riders may prefer a greater lever dead-band, which allows them to at least partially actuate the lever without producing any braking effect.

In a conventional lever actuated master cylinder assembly, one method to perform a lever dead-band adjustment is to adjust a piston stop, which adjusts the distance from a primary cup to a port timing hole. A modification in this regard can alter various other aspects of how the lever operates, such as the lever's overall non-actuated position relative to the handlebars (i.e., lever reach) and the lever ratio. As such, these other aspects would need to be adjusted as well to compensate for the lever dead-band adjustment. This results in a system that cannot be quickly or easily tuned. In addition, some other conventional adjustment methods, such as using an oblong primary cup lip, or an adjustable lever stop with biasing spring, can provide a lever dead-band adjustment, although they also include several drawbacks, for example, a diminished lever feel and a highly limited level of adjustability.

Further, in some other conventional lever master cylinder assemblies, adjustment of the lever dead-band can be performed during the manufacturing of the lever master cylinder assembly, although such adjustments by the manufacturer involve modifications performed during the assembly process and not to the assembled and/or installed assembly. As such, these adjustments would not be available to the operator of a vehicle utilizing the assembly, particularly without the use of tools and/or during operation of the vehicle.

### BRIEF SUMMARY OF THE INVENTION

In at least some embodiments, the method and apparatus for lever stroke adjustment relates to an apparatus for lever stroke adjustment that includes, a master cylinder body having a master cylinder body wall at least partially bounding an inside of the master cylinder body, a piston bore situated substantially inside the master cylinder body, a rotatable cam assembly extending through the master cylinder body wall and into the piston bore, the cam assembly having a cam shaft with a lobe portion positioned in the piston bore and a cam lever positioned outside of the master cylinder body. The apparatus further includes a piston positioned in the piston bore and configured for external actuation, the piston having a compression passage in communication with and adjacent to a shaft passage, wherein the compression passage includes a first sealing surface at an interface between the compression passage and shaft passage, and a poppet valve having an elongated poppet shaft that extends at least partially through the shaft passage, the poppet valve having a first poppet end with a poppet actuating surface and a second poppet end with a second sealing surface, wherein rotation of the cam assembly varies the distance between the first sealing surface and the second sealing surface.

In still additional other embodiments, the method and apparatus for lever stroke adjustment relates to a lever master cylinder assembly that includes, a master cylinder assembly configured for securing to a handlebar of a vehicle, the master cylinder assembly including a master cylinder body having an interior and exterior, and a master cylinder body wall situated there between, a lever assembly pivotally secured to the master cylinder body having a lever for pivotal actuation, a pushrod assembly situated substantially between the master cylinder assembly and the lever assembly, wherein the pushrod assembly includes a pushrod pivotally secured to the lever assembly. The lever master cylinder assembly further includes, a cam assembly having a cam lever positioned on the exterior of the master cylinder body and a cam lobe positioned on the interior of the master cylinder body, a piston assembly situated in a piston bore of the master cylinder body, the piston assembly including a piston in operable association with the pushrod and the lever, wherein the piston is actuatable by the lever and includes a first sealing surface, and a poppet valve situated inside the piston assembly, the poppet valve having a first poppet end with a poppet actuating surface and a second poppet end with a second sealing surface, wherein rotation of the cam assembly by the cam lever, varies the distance between the first sealing surface and the second sealing surface.

In still yet additional other embodiments, the method and apparatus for lever stroke adjustment relates to a method of lever stroke adjustment that includes rotating a cam lobe portion positioned in a piston bore using a cam lever protruding from a master cylinder body, the master cylinder body in operable association with a lever pivotably secured thereto, and upon rotation of the cam lobe, adjusting the position of a poppet valve situated inside the piston bore and in operable association with the cam lobe, wherein adjusting the position of the poppet valve using the cam lever increases or decreases the deadstroke of the lever. The method of lever stroke adjustment can further include manually rotating the cam lever without the use of a tool.

Other embodiments, aspects, features, objectives and advantages of the present invention will be understood and appreciated upon a full reading of the detailed description and the claims that follow.

### BRIEF DESCRIPTION OF THE DRAWINGS

Features of the method and apparatus for lever stroke adjustment which are believed to be novel are set forth with particularity in the appended claims. Embodiments of the method and apparatus for lever stroke adjustment are disclosed with reference to the accompanying drawings and are for illustrative purposes only. The method and apparatus for lever stroke adjustment is not limited in its application to the details of construction or the arrangement of the components illustrated in the drawings. Rather, the method and apparatus for lever stroke adjustment is capable of other embodiments or of being practiced or carried out in other various ways. In the drawings:

FIG. 1 is a perspective view of an exemplary lever master cylinder assembly;

FIG. 2 is a side view of the lever master cylinder assembly of FIG. 1, in accordance with at least some embodiments;

FIG. 3 is a front view of the lever master cylinder assembly of FIG. 1, in accordance with at least some embodiments;

FIG. 4 is a back view of the lever master cylinder assembly of FIG. 1, in accordance with at least some embodiments;

FIG. 5 is an exploded view of the lever master cylinder assembly of FIG. 1, in accordance with at least some embodiments;

FIG. 6 is an exploded view of a piston assembly of FIG. 5, in accordance with at least some embodiments;

FIG. 7 is a front view of the cam assembly of FIG. 5, in accordance with at least some embodiments;

FIG. 8 is a side view of the cam assembly of FIG. 5, in accordance with at least some embodiments;

FIG. 9 is a back view of the cam assembly of FIG. 5, in accordance with at least some embodiments;

FIG. 10 is a cross-section view taken along line 10-10 of FIG. 7, in accordance with at least some embodiments;

FIG. 11 is a cross-sectional side view of the lever master cylinder assembly of FIG. 1, with the cam assembly in a minimum lever dead-band adjustment position, in accordance with at least some embodiments;

FIG. 12 is an enlarged detail view of the lever master cylinder assembly of FIG. 11 at 12-12, in accordance with at least some embodiments;

FIG. 13 is a cross-sectional front view of the lever master cylinder assembly of FIG. 1, with the cam assembly in a minimum lever dead-band adjustment position, in accordance with at least some embodiments;

FIG. 14 is an enlarged detail view of the lever master cylinder assembly of FIG. 13 at 14-14, in accordance with at least some embodiments;

FIG. 15 is an enlarged detail view of the lever master cylinder assembly of FIG. 13 at 14-14, modified to show a piston actuated a minimum distance, in accordance with at least some embodiments;

FIG. 16 is an enlarged detail view of the lever master cylinder assembly of FIG. 11 at 12-12, modified to show the piston actuated a distance greater than the minimum distance, in accordance with at least some embodiments;

FIG. 17 is an enlarged detail view of the lever master cylinder assembly of FIG. 13 at 14-14, modified to show the piston actuated a distance greater than the minimum distance, in accordance with at least some embodiments;

FIG. 18 is a cross-sectional side view of the lever master cylinder assembly of FIG. 1, with the cam assembly in a maximum lever dead-band adjustment position, in accordance with at least some embodiments;

FIG. 19 is an enlarged detail view of a portion of the lever master cylinder assembly of FIG. 18 at 19-19, in accordance with at least some embodiments;

FIG. 20 is a cross-sectional front view of the lever master cylinder assembly of FIG. 1, with the cam assembly in a maximum lever dead-band adjustment position, in accordance with at least some embodiments;

FIG. 21 is an enlarged detail view of a portion of the lever master cylinder assembly of FIG. 20 at 21-21, in accordance with at least some embodiments;

FIG. 22 is an enlarged detail view of the lever master cylinder assembly of FIG. 20 at 21-21, modified to show the piston actuated a minimum distance, in accordance with at least some embodiments; and

FIG. 23 is a cross-sectional partial side view of the lever master cylinder assembly of FIG. 1, with the cam assembly in a moderate lever dead-band adjustment position, in accordance with at least some embodiments.

### DETAILED DESCRIPTION OF THE PREFERRED EMBODIMENT

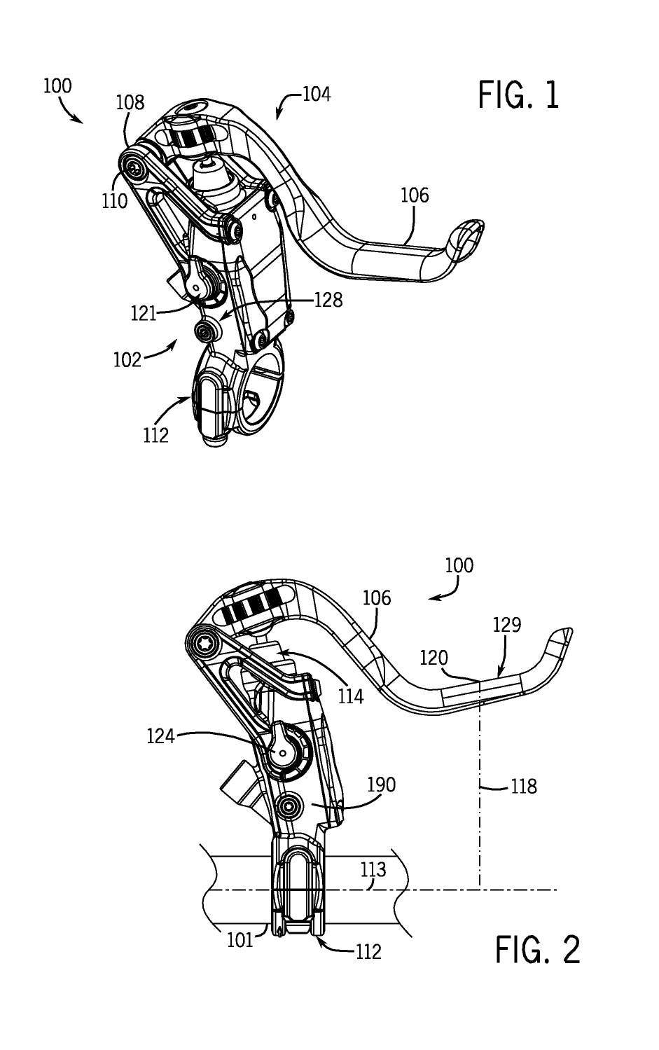

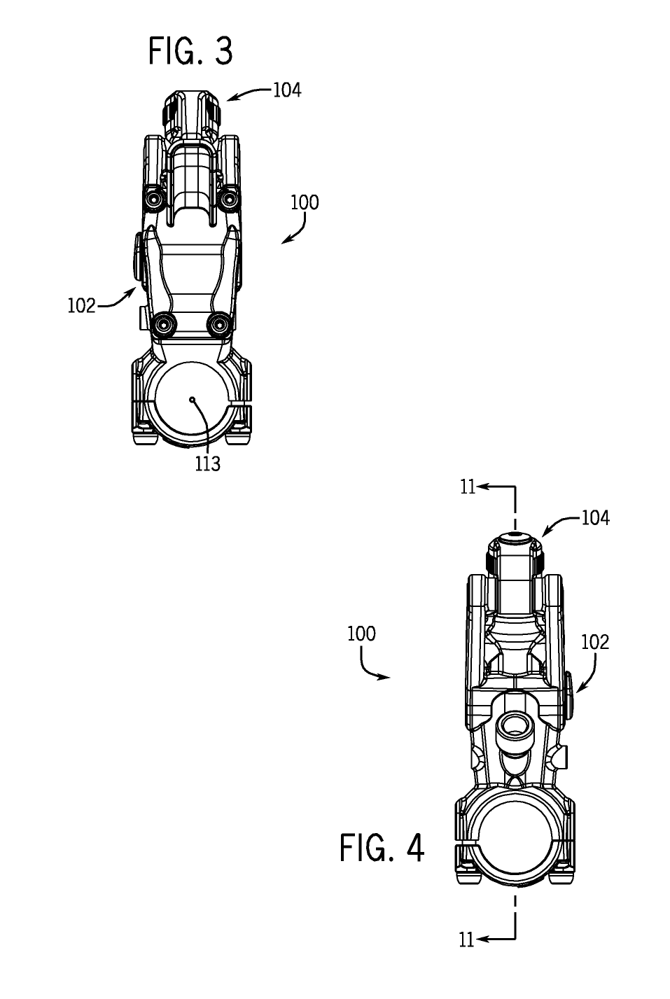

Referring to FIGS. 1, 2, 3, and 4, an exemplary lever master cylinder assembly 100 is shown, in accordance with at least some embodiments. The lever master cylinder assembly 100 is configured for mounting on a handlebar 101 of a vehicle (not shown) and actuating a system, such as a braking system (not shown) or a clutch system (not shown). Although the lever master cylinder assembly 100 is capable of operating various types of systems on numerous types of vehicles, such as bicycles and motorcycles, for exemplary purposes, the lever master cylinder assembly 100 is principally described herein as operating in conjunction with a braking system on a bicycle. The braking system is to be understood to include various conventional components, such as brake lines and brake calipers, and to utilize brake fluid for hydraulically actuating the brake calipers.

The lever master cylinder assembly 100 includes a master cylinder assembly 102 and a lever assembly 104. The master cylinder assembly 102 includes a master cylinder body 128 having a master cylinder body wall 190 that at least partially bounds a cylinder assembly interior 117 of the master cylinder body 128. The lever assembly 104 includes a lever 106 pivotally secured to a fulcrum 108 of the master cylinder assembly 102 by one or more pivot pins 110. The lever 106 provides an external actuator for the master cylinder assembly 102. The lever master cylinder assembly 100 is positioned for hand actuation, with the master cylinder assembly 102 configured to be secured to the handlebar 101 using a fastening mechanism, such as a clamp 112 secured to or formed integrally with the master cylinder assembly 102. The clamp 112 includes a centerline 113 and the lever 106 includes a finger grip area 129 having a central grip portion 120. When the lever 106 is in a non-actuated position, a lever distance 118 extends between the centerline 113 and the central grip portion 120 (FIG. 2). During actuation of the lever 106, the lever distance 118 is reduced.

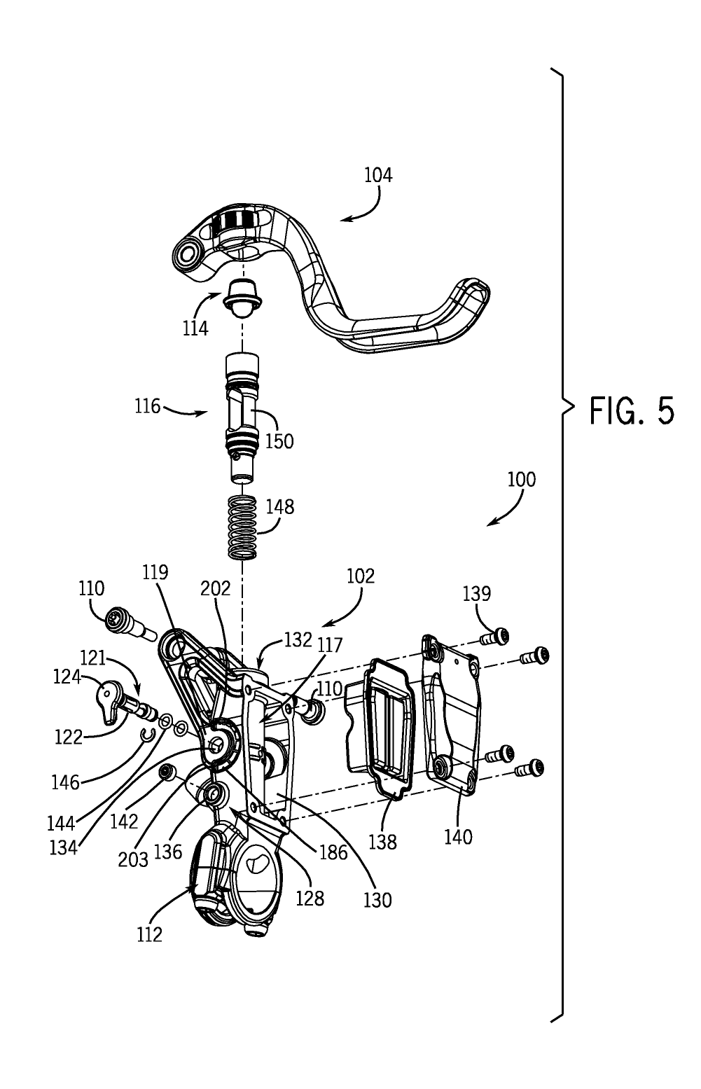

The master cylinder assembly 102 is actuated by grasping the lever 106 about the grip portion 120 and pulling it towards the handlebar 101. This causes the lever assembly 104 to act on the master cylinder assembly 102, which in turn pressurizes the braking system. More particularly, the lever 106 is connected to a pushrod assembly 114 that is configured to actuate a piston assembly 116 (FIG. 5) positioned in the master cylinder assembly 102. Actuation of the piston assembly 116 generates the fluid pressure to actuate the braking system, thereby applying the brake(s) on the bicycle. The distance the lever 106 travels from its non-actuated position to a position where fluid pressure is first generated by the piston assembly 116 for actuating the braking system is considered the lever dead-band.

Referring additionally to FIG. 5, an exploded view of the master cylinder assembly 102 is provided along with the lever assembly 104. As discussed herein, the lever dead-band can be adjusted conveniently by a rider manually without the use of tools (i.e., tool-less), even while riding the vehicle, by utilizing an adjustable cam assembly 121. In this manner, a rider can easily modify their vehicle to accommodate varied terrain during a ride. The adjustable cam assembly 121 includes a cam 122 positioned at least partially within the cylinder assembly interior 117 of the master cylinder body 128, and a cam lever 124 that is positioned at least partially on the outside of the master cylinder body 128 and adjacent a cylinder assembly exterior surface 119. In at least some embodiments, the cam 122 is positioned within or substantially within the cylinder assembly interior 117 of the master cylinder body 128, and the cam lever 124 is positioned outside or substantially outside of the master cylinder body 128 and adjacent the cylinder assembly exterior surface 119. Further, in at least some embodiments, the cylinder assembly exterior surface 119 includes the surface that extends along the exterior of the master cylinder body wall 190. In addition, in at least some embodiments, the cylinder assembly interior 117 includes the area interior of the cylinder assembly exterior surface 119 and reservoir cover 140, when the master cylinder assembly 102 is fully assembled.

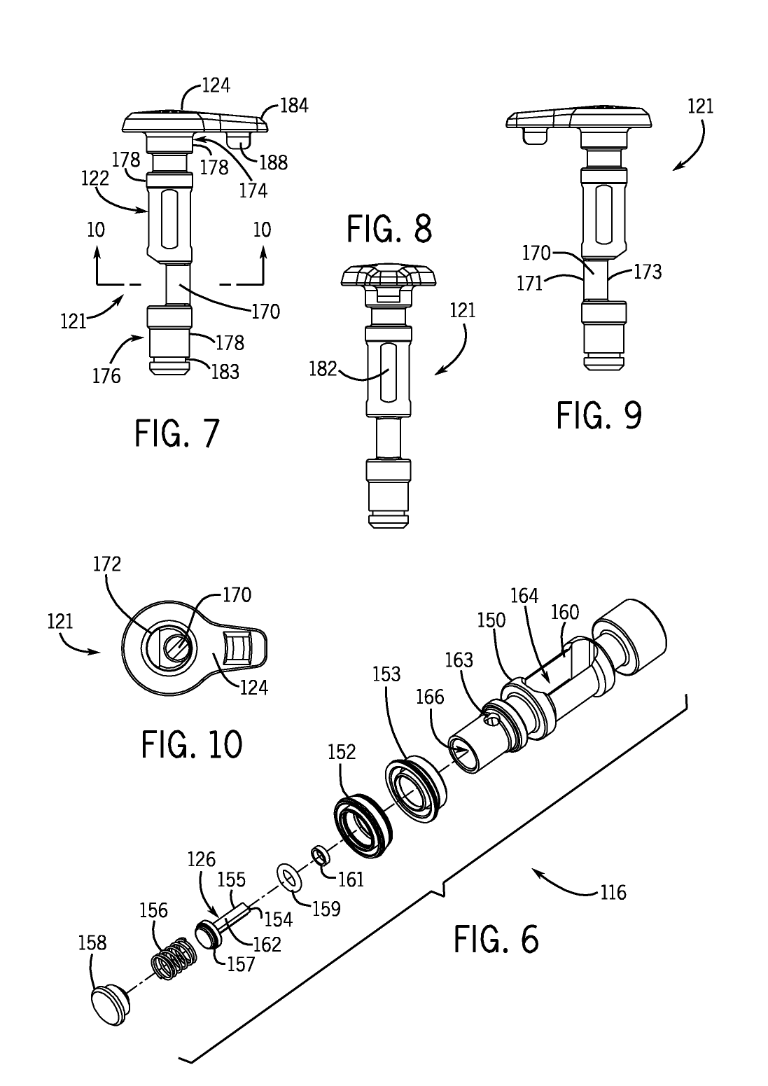

Adjustment of the lever dead-band is accomplished by rotating the cam lever 124, which in turn rotates the cam 122. Rotation of the cam 122 alters the position of a poppet valve 126 (FIG. 6) that is situated inside the piston assembly 116. The position of the poppet valve 126 in turn, establishes when the piston assembly 116 will begin to pressurize the braking system. By positioning the cam lever 124 at least partially outside the master cylinder assembly 102, the cam 122 can be rotated without the need for disassembly of the master cylinder assembly 102.

Referring still to FIG. 5, the master cylinder assembly 102 includes a master cylinder body 128, which in at least some embodiments, forms at least in part, an exterior master cylinder body wall 190, a fluid reservoir 130, a piston bore 132, a cam passage 134, and a bleed port 136. In addition, a reservoir bladder 138 and reservoir cover 140 are provided along with one or more fasteners 139 to cover and seal the fluid reservoir 130. Also, a bleed screw 142 is provided to seal the bleed port 136 and allow for bleeding of the master cylinder assembly 102 and braking system. Additionally, one or more O-ring seals 144 and a retention clip 146 can be provided to seal and retain the cam assembly 121 about the master cylinder body 128. Further, a piston 150 and a biasing piston return spring 148 are provided for insertion into the piston bore 132, with the return spring 148 serving to bias the piston 150 towards the pushrod assembly 114.

Referring now to FIG. 6, an exploded view of the exemplary piston assembly 116 is provided. The piston assembly 116 includes the piston 150 and one or more cup seals, such as a primary cup seal 152 and a secondary cup seal 153 for sealing the piston 150 while traveling in the cylinder bore. The piston assembly 116 further includes a poppet valve 126, a poppet spring 156, and a poppet plug 158. The piston 150 includes a cam passage 164 in operable association with a compression passage 166, and a shaft passage 168 (FIG. 12) that is situated between, and in communication with, the cam passage 164 and compression passage 166. The piston 150 further includes one or more fluid passages 163 for allowing fluid to flow between the compression passage 166 and a portion of the piston bore 132 identified as a compression chamber 165 (FIG. 12), wherein the compression chamber 165 is volumetrically variable in size depending on the actuated position of the piston 150 in the piston bore 132. The poppet valve 126 includes a first poppet end 155 having a poppet actuating surface 154 to interface with the cam 122 (FIG. 5) and a second poppet end 157 for sealing the shaft passage 168 from the compression passage 166, thereby preventing or substantially limiting fluid flow from the compression passage 166 through the shaft passage 168 to the cam passage 164 during actuation of the piston 150. The poppet valve 126 further includes a poppet shaft 162 that extends between the first poppet end 155 and second poppet end 157. The poppet shaft 162 is sized and shaped to be positioned substantially inside the shaft passage 168 and to translate therein.

In at least some embodiments, a valve seal 159 and a valve bushing 161 are provided at the opening of the shaft passage 168 to assist with the prevention of fluid flow from the compression passage 166 into the shaft passage 168 when the piston 150 is actuated. The valve bushing 161, in at least one embodiment, is comprised of a ring-shaped rigid material that serves to prevent excessive deformation of the valve seal 159 while under pressure from the poppet valve 126. The use of the valve bushing 161 allows for a reduction in the rigidity of the valve seal 159, as the valve seal 159 does not have to fully support the pressure from the poppet valve 126. Further, in at least some embodiments, the piston 150 includes a piston slot 160 formed therethrough, where the piston slot 160 forms at least a portion of the cam passage 164. Additionally, the piston slot 160 is sized to accommodate movement of the cam 122 as the piston 150 is actuated relative to the cam 122.

FIGS. 5, 7, 8, 9, and 10 provide views of the exemplary cam assembly 121. As discussed above, in at least some embodiments the cam assembly 121 serves to provide the mechanism for raising or lowering the poppet valve 126, which in turn provides the lever dead-band adjustment. The cam 122 of the cam assembly 121 includes a cam shaft 172 that extends along the length of the cam 122 between a first cam end 174 and a second cam end 176. In at least one embodiment, the cam shaft 172 includes one or more cylindrical mount portions 178 for rotatably mounting the cam 122 in the master cylinder body 128. A lobe portion 170 is situated between the first and second cam ends 174, 176 and is configured to be positioned in the piston bore 132. The lobe portion 170 is formed to include a high-point 171 that transitions to a low-point 173 to provide for a plurality of lever dead-band adjustments therebetween. In at least some embodiments, the lobe portion 170 is circular to provide a substantially smooth transitional surface for engaging the poppet actuating surface 154 during rotation of the cam 122, although in other embodiments, alternate shapes can be provided that form a substantially smooth transitional surface.

Further, in at least one embodiment, the cam 122 can include one or more grooves 182 that provide a fluid path between the piston bore 132 and the fluid reservoir 130 to increase fluid flow therebetween. In addition, the cam 122 can include a notched ring portion 183 at the second cam end 176 for receiving the retention clip 146 to secure the cam 122 about the master cylinder body 128. In at least some embodiments, one or more O-ring seals 144 are positioned between a pair of cylindrical mount portions 178 to prevent fluid from escaping the master cylinder body 128 about the first cam end 174. In other embodiments, O-ring seals 144 can be provided in more or less locations about the master cylinder assembly 102 to prevent the loss of fluid from an exit point of the cam 122 from the master cylinder body 128.

Referring to FIGS. 5 and 7, in at least some embodiments, the master cylinder body 128 includes a groove 186 having a first lever stop 202 and a second lever stop 203. The lever stops 202, 203 are positioned at the extents of the groove 186 and are configured to serve as mechanical stops for the cam lever 124 at minimum and maximum lever dead-band adjustment positions. In at least some embodiments, the cam lever 124 includes an indicating portion 184 that serves to provide a visual indication as to position of the cam 122, and a tab 188 configured to be received in the groove 186 and to abut the stops 202, 203 at the extents. Further, in at least some embodiments, the groove 186 is semi-circular and integrally formed with the master cylinder body 128.

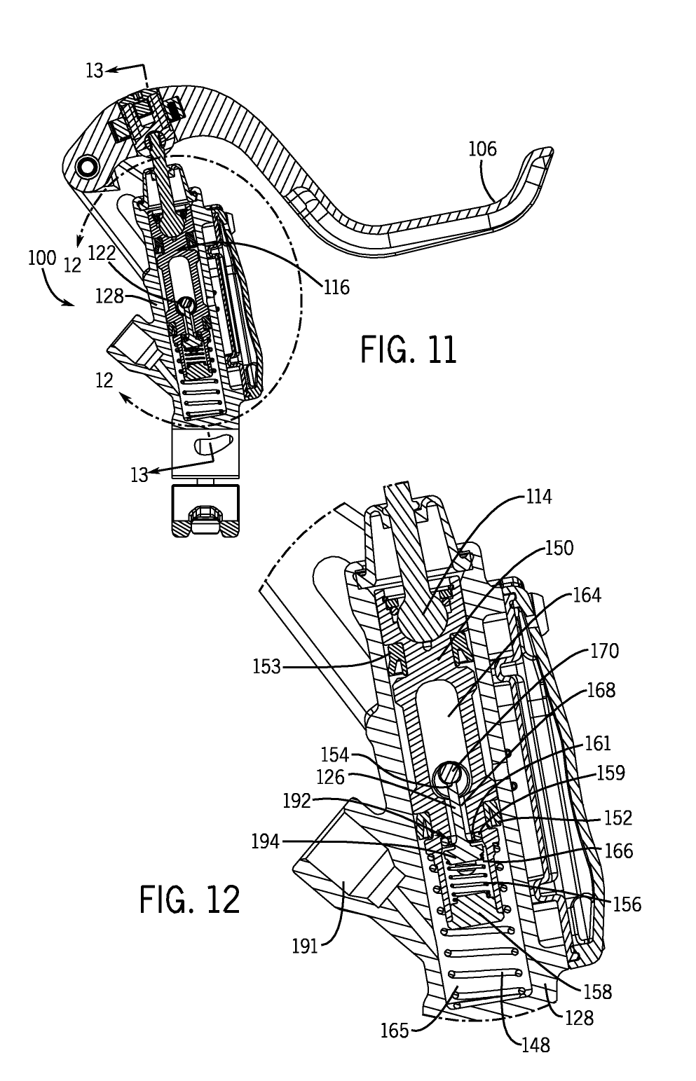

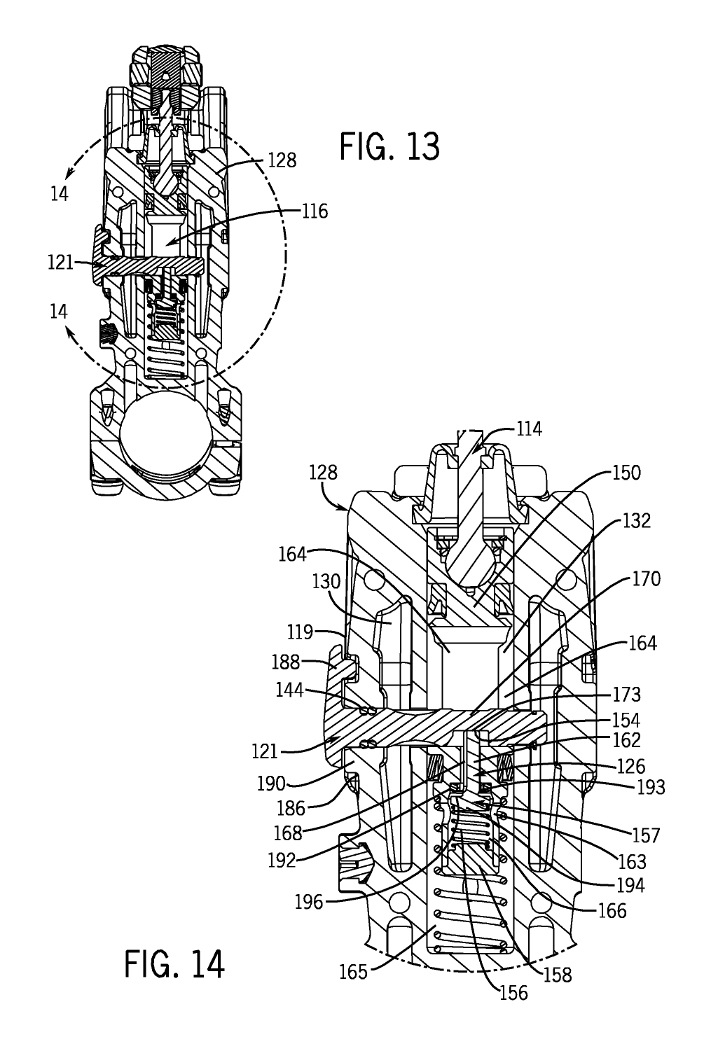

Referring to FIG. 11, a cross-sectional side view of the lever master cylinder assembly 100 of FIG. 4 at 11-11 is provided, depicting the lever adjustable assembly 100 set in a minimum lever dead-band adjustment position. FIG. 12 depicts an enlarged detailed view of a portion of the lever master cylinder assembly 100 of FIG. 11. Further illustration is provided in the cross-sectional front views shown in FIGS. 13 and 14. Referring particularly to FIG. 12, the piston 150 is shown in a non-actuated position. In this non-actuated position, the master cylinder assembly 102 allows fluid to flow between the fluid reservoir 130 and the master cylinder output port 191, via the compression chamber 165. The master cylinder output port 191 serves to interconnect the compression chamber 165 with the braking system, and is positioned about the fluid exit of the master cylinder assembly 102, adjacent to the compression chamber 165.

When braking is desired, the lever 106 is stroked, which actuates the piston 150, moving it deeper into the piston bore 132. The piston 150 consumes volumetric space in the piston bore 132 as it translates therethrough, thereby reducing the size of the compression chamber 165, which causes the fluid situated in the compression chamber to be displaced. If the fluid in the compression chamber 165 is allowed to flow through the compression passage 166 and into the shaft passage 168, then adequate fluid pressure will not be provided at the master cylinder output port 191 for communication to the braking system. To generate adequate fluid pressure at the master cylinder output port 191 during actuation of the piston 150, the fluid in the compression chamber 165 is to be prevented or substantially prevented from exiting the compression chamber 165 through the compression passage 166 into the shaft passage 168. To accomplish this, the poppet valve 126 is re-positioned during actuation of the piston 150 to seal the juncture between the compression passage 166 and the shaft passage 168. The sealing of the juncture is provided by a valve seat 192 and a poppet head 194.

More particularly, referring to FIGS. 13 and 14, the valve seat 192 is positioned in the compression passage 166 adjacent the shaft passage 168. In at least some embodiments, the valve seat 192 includes the valve seal 159 situated thereon to form a first sealing surface 193. The poppet head 194 is positioned at the second poppet end 157 and includes a second sealing surface 196 that is configured to engage the first sealing surface 193. The distance between the first sealing surface 193 and the second sealing surface 196 establishes a seal gap 197 (best seen in FIG. 19). When the poppet valve 126 is in a closed position, the engagement of the sealing surfaces 193, 196 serves to prevent the flow of fluid from the compression passage 166 through the shaft passage 168. When the poppet valve 126 is in an open position, the lack of engagement of the sealing surfaces 193, 196 serves to allow the flow of fluid from the compression passage 166 through the shaft passage 168.

The poppet valve 126 is biased towards a closed position (seal gap closed) by the poppet spring 156 that exerts a force between the second poppet end 157 and the poppet plug 158, with the poppet plug 158 being secured to the piston 150. Although, when the piston 150 is in a non-actuated position, the poppet valve 126 remains in an open position by virtue of the poppet actuating surface 154 abutting against the cam lobe 170 to counter the biasing of the poppet spring 156. Actuation of the piston 150 removes the biasing of the cam lobe 170 against the poppet actuating surface 154, thereby allowing the poppet spring 156 to bias the poppet valve 126 into the closed position.

As seen in FIG. 14, the piston 150 is in a non-actuated position with the cam lever 124 set to a minimum lever dead-band adjustment position. In this position, the cam lobe 170 is positioned to abut the low-point 173 of the cam lobe 170 against the poppet actuating surface 154 and therefore, the poppet head 194 is biased closer to the cam passage 164, which sets the first and second sealing surfaces 193, 196 to a minimum distance apart.

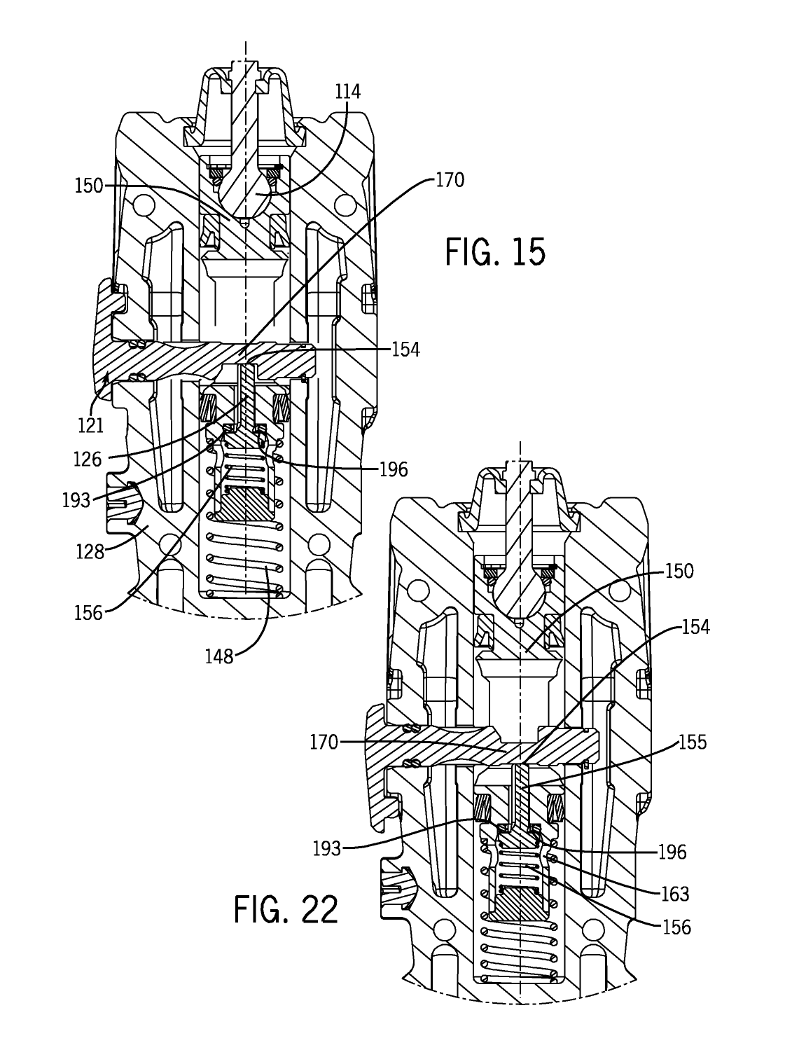

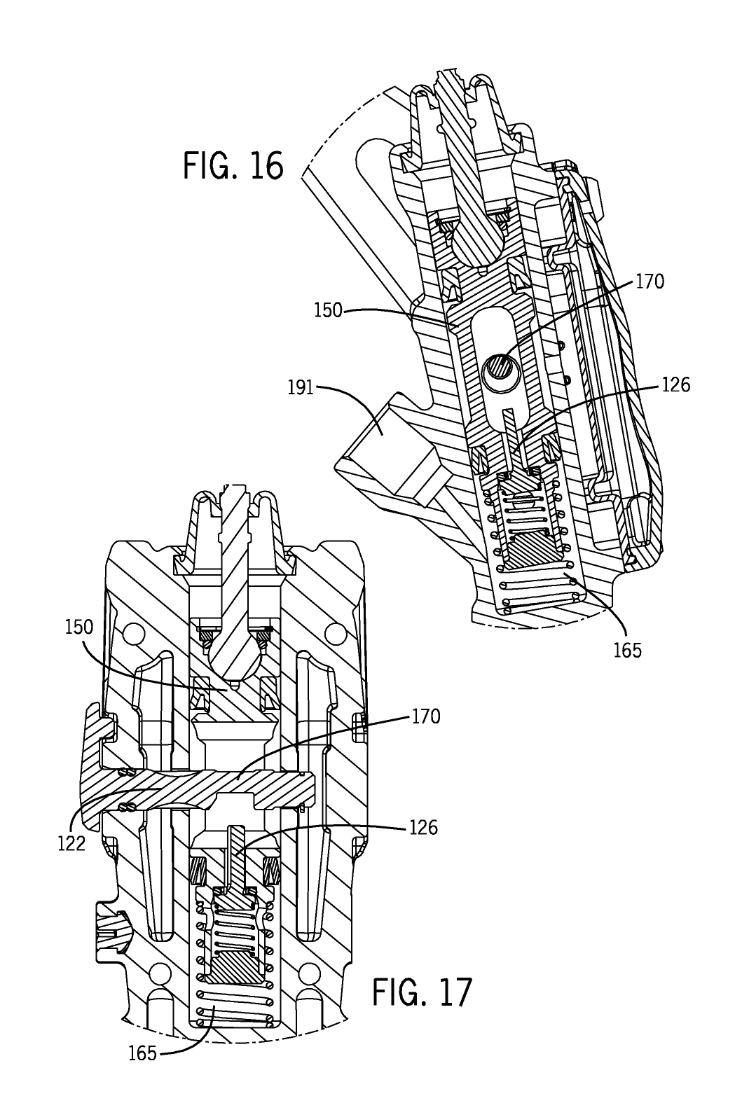

Referring to FIG. 15, the piston 150 is shown actuated enough to neutralize the bias of the cam lobe 170 against the poppet actuating surface 154, thereby allowing the sealing surfaces 193, 196 to be joined under the bias of the poppet spring 156. Once the sealing surfaces 193, 196 are joined, the flow of fluid through the shaft passage 168 is prevented, allowing for fluid pressure to be built up in the compression chamber 165 upon further actuation of the piston 150. As seen in FIGS. 16 and 17, continued actuation of the piston 150 pressurizes the fluid in the compression chamber 165, and therefore serves to push the fluid from the compression chamber 165 into the master cylinder outlet port 191 for actuating the braking system.

As discussed above, a lever dead-band adjustment can be performed to provide a minimal lever dead-band adjustment, resulting in a minimal lever stroke before activating the braking system. Alternatively, a maximum lever dead-band adjustment can be performed to provide a rider with a greater lever stroke before activating the braking system. Similar to the minimal lever dead-band adjustment, the maximum lever dead-band adjustment can be performed by the rider without tools, at any time, including while operating the vehicle.

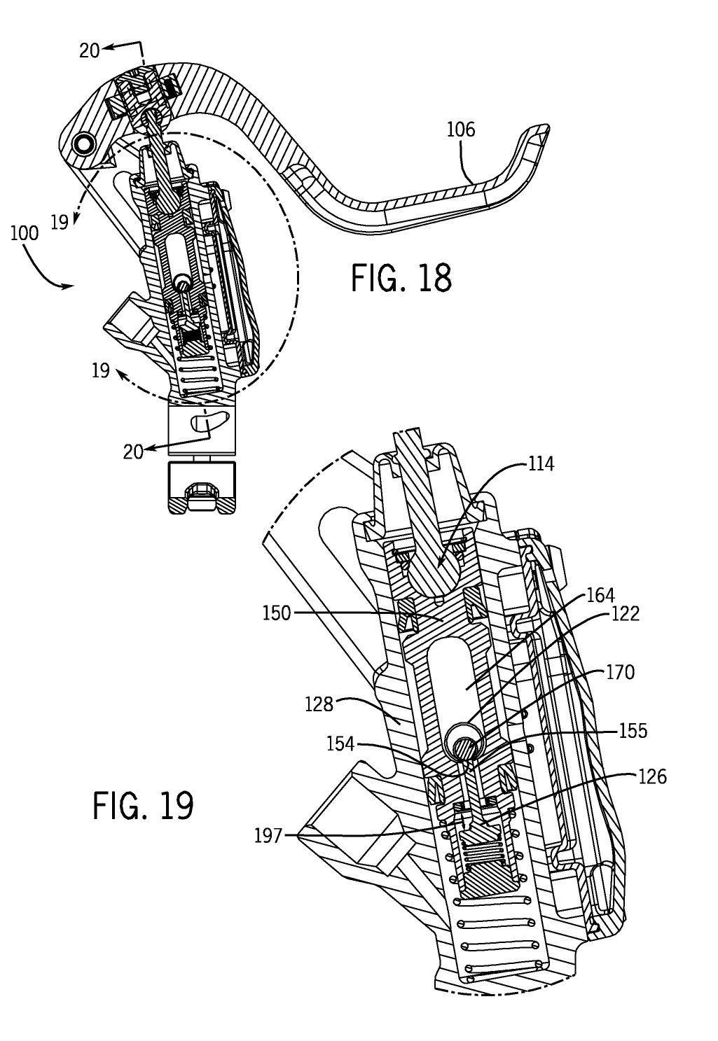

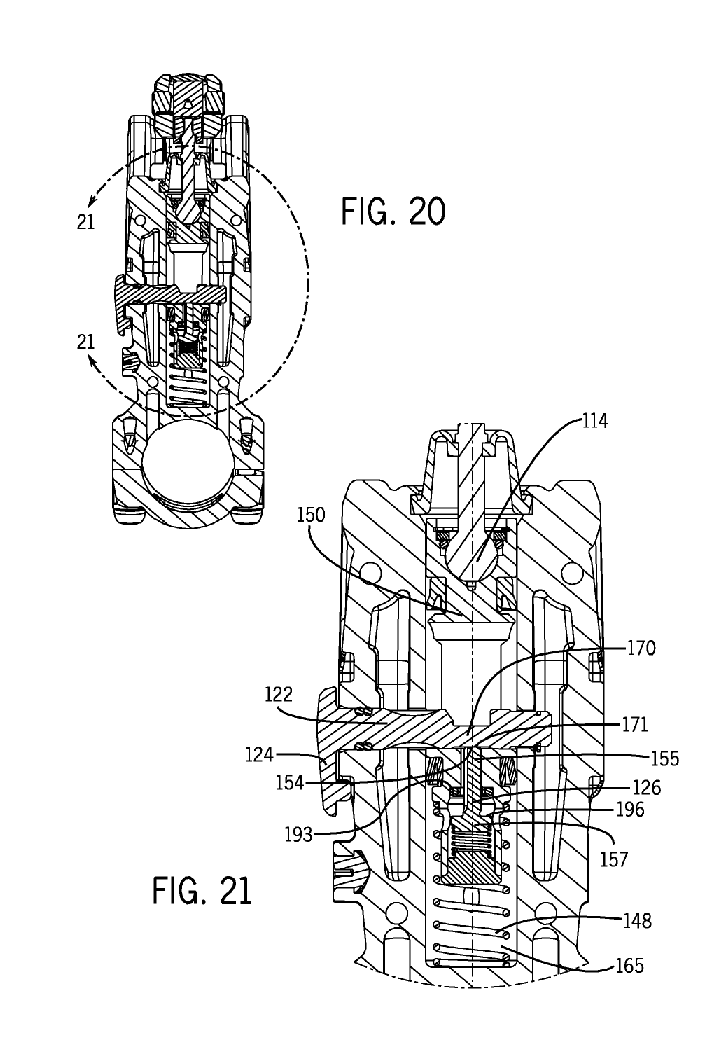

As seen in FIGS. 18-21, the cam lever 124 is situated in a maximum lever dead-band adjustment position, which includes the cam 122 being positioned with the high-point 171 of the lobe 170 abutting the poppet actuating surface 154. Referring particularly to FIGS. 20 and 21, it can be seen that upon rotation of the cam 122, via the cam lever 124, the first poppet end 155 is translated out of the cam passage 164 and further into the shaft passage 168. This repositioning of the poppet valve 126 increases the seal gap 197 by positioning the second sealing surface 196 a greater distance from the first sealing surface 193. As a result of the increased distance between the first sealing surface 193 and the second sealing surface 196, the piston 150 will require additional actuation from the lever 106, via the pushrod assembly 114, to neutralize the bias from the cam lobe 170 acting on the poppet actuating surface 154, thereby closing the seal gap 197. As seen in FIG. 22, the piston 150 is shown actuated to the point that the bias against the poppet actuating surface 154 (by the cam lobe 170) is neutralized, thereby allowing the sealing surfaces 193, 196 to be joined under the bias of the poppet spring 156.

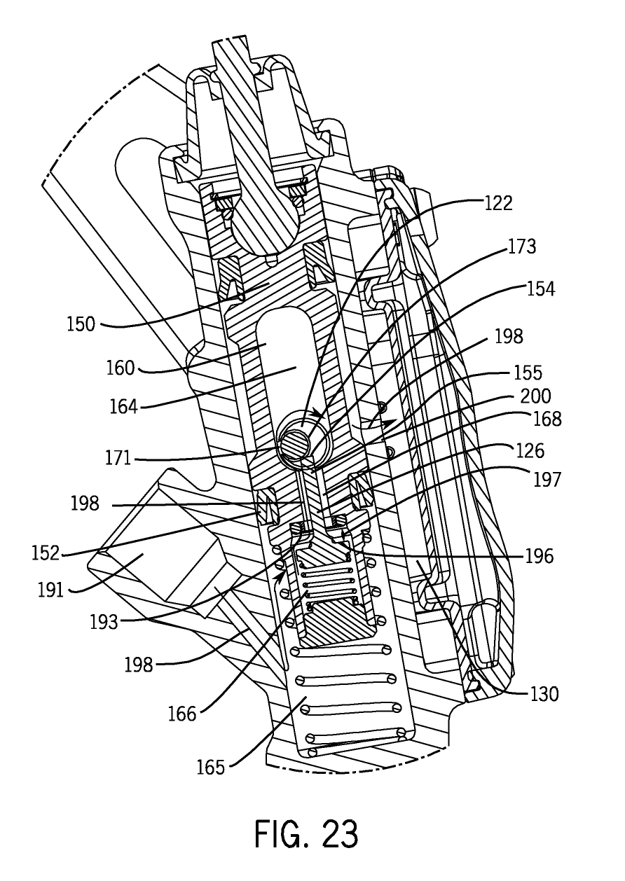

As discussed above, the cam assembly 121 can be adjusted to a plurality of lever dead-band positions between the minimum and maximum. FIG. 23 depicts the cam assembly 121 set to a moderate lever dead-band adjustment position, which positions the cam lobe 170 such that the poppet actuating surface 154 rests about a point substantially in-between the high-point 171 and the low-point 173. In this position, a moderate actuation of the piston 150 would result in the sealing surfaces 193, 196 being joined.

Still referring to FIG. 23, the master cylinder assembly 102 includes a fluid path 198 for the flow of fluid therethrough, which extends from the master cylinder output port 191 to the fluid reservoir 130. During operation of the braking system, the temperature of the fluid in the braking system increases, causing the fluid to expand. To accommodate for fluid expansion, the fluid path 198 allows the fluid to pass into the fluid reservoir 130. Likewise, during fluid contraction, fluid is allowed to pass out of the fluid reservoir 130 to compensate. More particularly, during fluid expansion, in at least one embodiment, the fluid path 198 includes the flow of fluid through the master cylinder output port 191, the compression chamber 165, the fluid passage 163 (FIG. 22), the compression passage 166, the seal gap 197, the shaft passage 168, the cam passage 164, the piston slot 160, the compensation port 200, and the fluid reservoir 130. The fluid path during fluid contraction is the reverse. Although the fluid path 198 is shown in FIG. 23 using multiple lines, it is to be understood that one or more components, such as the fluid passage 163 and piston slot 160, are not depicted in FIG. 23 in a manner that allows for the flow of fluid along the fluid path to be drawn continuously, although all the components that provide the fluid path are shown in one or more other FIGS.

By virtue of the fluid path 198 provided by the master cylinder assembly 102, the need for a conventional port-timing hole(s) extending between a fluid reservoir and a piston bore is eliminated. The elimination of the port-timing hole(s) serves to extend the service life of the primary cup seal 152. More particularly, when port-timing hole(s) are present, the primary cup seal 152 is repeatedly dragged across the one or more of the port-timing hole(s). This action forces the flexible material of the primary cup seal 152 to flex slightly into the machined port-timing hole(s) as it passes by, creating an abrasive action that degrades the primary cup seal 152 with use. In addition, the use of the aforementioned components that provide the fluid path 198 allow for a greater flow of fluid than provided by master cylinder assemblies that utilize conventional port-timing hole(s). Further, the fluid path 198 serves to provide for the flow of fluid from the fluid reservoir 130, which is necessary to compensate for brake pad wear that occurs in the braking system.

Notwithstanding the embodiments described above in relation to FIGS. 1-23, it is nevertheless contemplated that various refinements to the features described above, including addition of various features and components that are commonly employed in conjunction with, or as part of lever master cylinder assemblies and braking systems, are included. For example, various other sealing structures and mechanisms, anti-rotational rings and mechanisms and various friction-reducing devices, can be employed.

Further, despite any methods being outlined in a step-by-step sequence, the completion of acts or steps in a particular chronological order is not necessarily mandatory. Modification, rearrangement, combination, reordering, or the like, of acts or steps where such changes are appropriate for and maintain proper functioning of the method and apparatus for lever stroke adjustment in one or more of its various embodiments, is contemplated and considered within the scope of the description and claims.

Accordingly, it is specifically intended that the method and apparatus for lever stroke adjustment not be limited to the embodiments and illustrations contained herein but include modified forms of those embodiments including portions of the embodiments and combinations of elements of different embodiments as come within the scope of the following claims.

We claim:

1. An apparatus for lever stroke adjustment comprising:
a master cylinder body having a master cylinder body wall at least partially bounding an inside of the master cylinder body;
a piston bore situated substantially inside the master cylinder body;
a rotatable cam assembly extending through the master cylinder body wall and into the piston bore, the cam assembly having a cam shaft with a lobe portion positioned in the piston bore and a cam lever positioned outside of the master cylinder body;
a piston positioned in the piston bore and configured for external actuation, the piston having a compression passage in communication with and adjacent to a shaft passage, wherein the compression passage includes a first sealing surface at an interface between the compression passage and shaft passage; and
a poppet valve having an elongated poppet shaft that extends at least partially through the shaft passage, the poppet valve having a first poppet end with a poppet actuating surface and a second poppet end with a second sealing surface, wherein rotation of the cam assembly varies the distance between the first sealing surface and the second sealing surface.

2. The apparatus for lever stroke adjustment of claim 1 further including,
a pushrod assembly having a pushrod in communication with the piston; and
a lever assembly pivotally secured to the master cylinder body, having a lever in communication with the pushrod, wherein actuation of the lever translates the pushrod to actuate the piston.

3. The apparatus for lever stroke adjustment of claim 2, wherein rotation of the cam assembly does not require partial disassembly of the apparatus.

4. The apparatus for lever stroke adjustment of claim 1, wherein the poppet actuating surface of the first poppet end is in contact with the cam lobe when the piston is in a non-actuated position and the distance between the first sealing surface and the second sealing surface forms a seal gap therebetween.

5. The apparatus for lever stroke adjustment of claim 4, wherein tool-less actuation of the cam lever varies the seal gap.

6. The apparatus for lever stroke adjustment of claim 5, wherein the cam lobe further includes a high point and a low point, and wherein, when the high point is in contact with the poppet actuating surface, the seal gap is greater than when the low point is in contact with the poppet actuating surface.

7. The apparatus for lever stroke adjustment of claim 6, wherein the master cylinder body includes both a fluid reservoir configured to supply fluid to the piston bore and a master cylinder output port configured to communicate the fluid to a braking system.

8. The apparatus for lever stroke adjustment of claim 7, wherein the piston further includes a cam passage in communication with the compression passage via the shaft passage, and wherein the cam passage includes a piston slot for accommodating the actuation of the piston about the cam shaft.

9. The apparatus for lever stroke adjustment of claim 7, wherein the master cylinder body is configured for securement to a handlebar of a bicycle and the master cylinder output port is configured for communication with a disc brake caliper.

10. The apparatus for lever stroke adjustment of claim 8, wherein the cam lever is actuatable while operating the bicycle.

11. The apparatus for lever stroke adjustment of claim 7, further including:
a variable compression chamber situated inside the piston bore;
a fluid passage positioned between the compression chamber and the compression passage; and
a compensation port positioned between the piston bore and the fluid reservoir, wherein an open fluid path extends through the master cylinder output port, the compression chamber, the fluid passage, the compression passage, the seal gap, the shaft passage, the cam passage, the piston slot, the compensation port, and the fluid reservoir when the piston is in a non-actuated position.

12. The apparatus for lever stroke adjustment of claim 11, wherein the fluid reservoir lacks a port timing hole extending between the piston bore and the fluid reservoir for communicating fluid between the piston bore and the fluid reservoir during non-actuation of the piston and preventing the flow of fluid between the piston bore and the fluid reservoir during at least a portion of the actuation of the piston.

13. A lever master cylinder assembly comprising:
a master cylinder assembly configured for securing to a handlebar of a vehicle, the master cylinder assembly including a master cylinder body having an interior and an exterior, and a master cylinder body wall situated therebetween;
a lever assembly pivotally secured to the master cylinder body having a lever for pivotal actuation;
a pushrod assembly situated substantially between the master cylinder assembly and the lever assembly, wherein the pushrod assembly includes a pushrod pivotally secured to the lever assembly;
a cam assembly having a cam lever positioned on the exterior of the master cylinder body and a cam lobe positioned on the interior of the master cylinder body;
a piston assembly situated in a piston bore of the master cylinder body, the piston assembly including a piston in operable association with the pushrod and the lever, wherein the piston is actuatable by the lever and includes a first sealing surface; and
a poppet valve situated inside the piston assembly, the poppet valve having a first poppet end with a poppet actuating surface and a second poppet end with a second sealing surface, wherein rotation of the cam assembly by the cam lever varies the distance between the first sealing surface and the second sealing surface.

14. The lever master cylinder assembly of claim 13, wherein the poppet actuating surface is in contact with the cam lobe when the piston is in a non-actuated position and the distance between the first sealing surface and the second sealing surface forms a seal gap therebetween.

15. The lever master cylinder assembly of claim 14, wherein tool-less actuation of the cam lever varies the seal gap.

16. The lever master cylinder assembly of claim 15, wherein the cam lobe further includes a high point and a low point, wherein when the high point is in contact with the poppet actuating surface the seal gap is greater than when the low point is in contact with the poppet actuating surface.

17. The lever master cylinder assembly of claim 16, wherein the master cylinder body includes both a fluid reservoir configured to supply fluid to the piston bore and a master cylinder output port configured to supply the fluid to a braking system.

18. The lever master cylinder assembly of claim 17, wherein the master cylinder output port is configured to supply pressurized fluid to a brake caliper, and wherein the tool-less actuation of the cam lever is performed by an operator of the vehicle while operating the vehicle.

19. The lever master cylinder assembly of claim 16, wherein the master cylinder body is in operable communication with one or more brake lines for supplying hydraulic pressure to one or more brakes on a bicycle, and wherein the master cylinder body and brake lines provide a sealed braking system containing brake fluid.

20. The lever master cylinder assembly of claim 19, wherein rotation of the cam assembly does not require breaching the sealed braking system.

21. A method of lever stroke adjustment comprising:
rotating a cam lobe portion positioned in a piston bore using a cam lever protruding from a master cylinder body, the master cylinder body in operable association with a lever pivotably secured thereto; and
upon rotation of the cam lobe, adjusting the position of a poppet valve situated inside the piston bore and in operable association with the cam lobe, wherein adjusting the position of the poppet valve using the cam lever increases or decreases the deadstroke of the lever.

22. The method of lever stroke adjustment of claim 21 further comprising:
manually rotating the cam lever without the use of a tool;
providing a piston positioned in the bore and configured for external actuation, the piston having a compression passage in communication with and adjacent to a shaft passage, wherein the compression passage includes a first sealing surface at an interface between the compression passage and shaft passage; and
providing a poppet valve having an elongated poppet shaft that extends at least partially through the shaft passage, the poppet valve having a first poppet end with a poppet actuating surface and a second poppet end with a second sealing surface, wherein rotation of the cam assembly varies the distance between the first sealing surface and the second sealing surface.
